(19) United States
(12) Patent Application Publication
(10) Pub. No.: US 2019/0147238 A1
(43) Pub. Date: May 16, 2019

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Tomotoshi Kanatsu, Tokyo (JP)

(21) Appl. No.: 16/179,728

(22) Filed: Nov. 2, 2018

(30) Foreign Application Priority Data
Nov. 15, 2017 (JP) 2017-220309

(51) Int. Cl. G06K 9/00; G06K 9/72

(52) U.S. Cl. CPC G06K 9/00456; G06K 2209/01; G06K 9/72; G06K 9/00449

(57) ABSTRACT

An information processing apparatus of the present invention including: an acquisition unit configured to acquire a partial image acquired by capturing a portion of a subject including character strings; a storage unit configured to store a candidate character string among character strings recognized in the partial image in association with a full image obtained by capturing the entire subject; a specifying unit configured to specify a character string to be obtained by evaluating the candidate character string by using a condition relating to the candidate character string stored in the storage unit; and a generating unit configured to generate a partial image of the subject, the partial image of the subject including the character string to be obtained that is specified by the specifying unit.

### BACKGROUND OF THE INVENTION

### Field of the Invention

The present invention relates to an extracting technique of character information included in an image.

### Description of the Related Art

Recently, various techniques have been developed for acquiring text information included in images by performing character recognition processing (OCR processing) on the images acquired by capturing images (hereinafter referred to as captured images) of a paper document with a portable device such as a smartphone or tablet having a camera function.

The images acquired by using a hand-held portable device tend to be affected by a capturing environment as compared to the images acquired by using a scanner. More specifically, the captured images may have a low quality due to camera shake or the like. The captured images may also have a low capturing resolution compared to those acquired by using the scanner. In a case of acquiring character information from a captured image acquired by capturing the entire area of a target paper document so as to fit within the angle of view of a camera, a character recognition result may have a low accuracy if pixels that form characters are very few.

In contrast to this, a technique for coping with the above problem is disclosed in Japanese Patent Laid-open No. 2005-55969, where a plurality of character recognition results individually obtained from a plurality of captured images (partial images), each including a portion of a paper business form, are combined by alignment so as to increase the number of matching characters.

### SUMMARY OF THE INVENTION

The present invention provides a technique to efficiently obtain a favorable character recognition result of a subject while suppressing a processing load.

According to one aspect of the present invention, an information processing apparatus includes: an acquisition unit configured to acquire a partial image obtained by capturing a portion of a subject including character strings; a storage unit configured to store a candidate character string among character strings recognized in the partial image in association with a full image obtained by capturing the entire subject; a specifying unit configured to specify a character string to be obtained by evaluating the candidate character string by using a condition relating to the candidate character string stored in the storage unit; and a generating unit configured to generate a partial image of the subject, the partial image of the subject including the character string to be obtained that is specified by the specifying unit.

Further features of the present invention will become apparent from the following description of exemplary embodiments with reference to the attached drawings.

### BRIEF DESCRIPTION OF THE DRAWINGS

FIG. 1A and FIG. 1B are diagrams showing examples of appearance of a mobile terminal;

FIG. 2 is a diagram showing an example of a software configuration of the mobile terminal;

FIG. 3 is a flowchart of exemplary operation of the mobile terminal;

FIG. 4A and FIG. 4B are tables showing exemplary item specifying rules used by the mobile terminal;

FIG. 5 is a flowchart of an example of a processing content in S309 of FIG. 3;

FIG. 6A is a flowchart of an example of a processing content in S503 of FIG. 5;

FIG. 6B is a flowchart of an example of a processing content in S504 of FIG. 5;

FIG. 7 is a diagram showing an example of a paper business form and a capture area used in a first embodiment of the present invention;

FIG. 8A is a diagram showing an example of a paper business form and a capture area used in a second embodiment of the present invention;

FIG. 8B and FIG. 8C are exemplary item specifying rules used in the second embodiment of the present invention; and

FIG. 9 is a flowchart of another example of a processing content in S504 of FIG. 5.

### DESCRIPTION OF THE EMBODIMENTS

In Japanese Patent Laid-open No. 2005-55969, if an obtainable captured image has a low capturing resolution and includes a plurality of similar character strings or few matching characters, alignment of character strings may not be appropriately performed, failing to obtain a highly accurate character recognition result. Increasing the number of captured images or performing evaluation using a condition indicating reliability of recognition results may be conceivable, and this may increase a processing load in proportion to the number of captured images and evaluation targets.

Incidentally, there is a need for a technique of reading a character string corresponding to an item name from a captured image of a paper business form as an item value to be obtained. For example, Japanese Patent Laid-open No. 2011-248609 discloses a technique of performing character recognition processing on a business form image acquired by capturing the entire business form, calculating an item name, an item value, and a likelihood of arrangement, and determining a association between an item name and an item value based on the calculation result. The techniques of Japanese Patent Laid-open No. 2005-55969 and Japanese Patent Laid-open No. 2011-248609 may be combined to read an item value associated with an item name from a partial image of the paper business form. However, a likelihood may not be appropriately calculated, failing to determine a correspondence between an item name and an item value in the partial image. Furthermore, since a likelihood is calculated for all of the character strings in each partial image, a processing load may increase in proportion to the number of captured images and character strings.

Hereinafter, embodiments of the present invention will be described with reference to the drawings. It should be noted that elements described in the embodiments are exemplary only and are not intended to limit the scope of the present invention. Further, all of the combinations of the elements described in the embodiments are not always essential to solve a problem.

### First Embodiment

### <Appearance>

Examples of an information processing apparatus according to the present embodiment include a mobile terminal which is a portable information processing apparatus having a camera function such as a tablet PC and a smartphone.

The mobile terminal will be described as one of the examples of the information processing apparatus. The mobile terminal is an example of a portable communication terminal and is a terminal that can be used at any location, with implementation of a wireless communication function and the like.

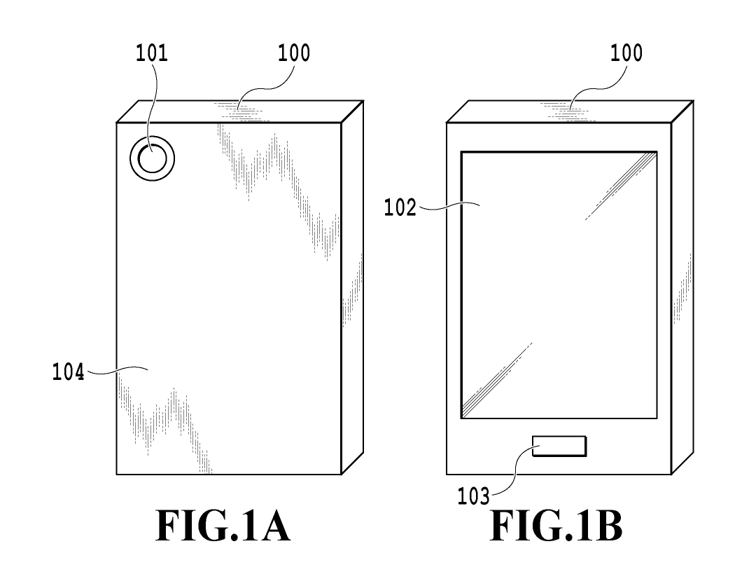

FIG. 1A and FIG. 1B are diagrams showing examples of appearance of the mobile terminal. FIG. 1A shows the mobile terminal as viewed from the face side (front side). FIG. 1B shows the mobile terminal as viewed from the rear side (back side). A mobile terminal 100 has an imaging unit (camera) 101, a display unit 102, a button 103, and a communication unit 104. The front of the mobile terminal 100 has the imaging unit 101. The back of the mobile terminal 100 has the display unit 102 and the button 103.

The imaging unit 101 is a device that acquires a real-world view as image data. The imaging unit 101 is composed of a lens and an imaging element, for example. The display unit 102 is a device that displays the image data acquired by the imaging unit 101 so as to allow a user to visually confirm. Examples of the display unit 102 include a liquid crystal display. The button 103 is an interface which the user uses for operation on the mobile terminal 100 such as the start and end of capturing. Examples of the button 103 include a mechanical or pressure-sensitive button. These are only examples, and the display unit 102 may be, for example, a liquid crystal display serving as a touch panel having also a function of the button 103. The communication unit 104 is embedded in the mobile terminal 100 and is wirelessly connected to an intranet/Internet so that it can exchange data with an external server and the like.

The imaging unit 101 is a device that can acquire data as a plurality of captured images, i.e., a captured moving image, acquired by continuously capturing a subject for a certain period of time. In other words, the imaging unit 101 is a device that can capture a plurality of frames of images that form a moving image at predetermined capture intervals. The predetermined capture intervals may be set at 30 times or 60 times or etc. per second, for example. As the details will be described later, the captured moving image is immediately displayed on the display unit 102 of the mobile terminal 100, so that the user can recognize the current capture area of the subject. Furthermore, the mobile terminal 100 may have a function of recognizing a content of a character string included in the captured image and, after acquiring relevant information, displaying the information in association with the display of the captured moving image. Alternatively, the acquired information may be transmitted from the communication unit 104 to the external server and the like.

### <Software Configuration (Mobile Terminal)>

Next, software configuration of the mobile terminal 100 will be described.

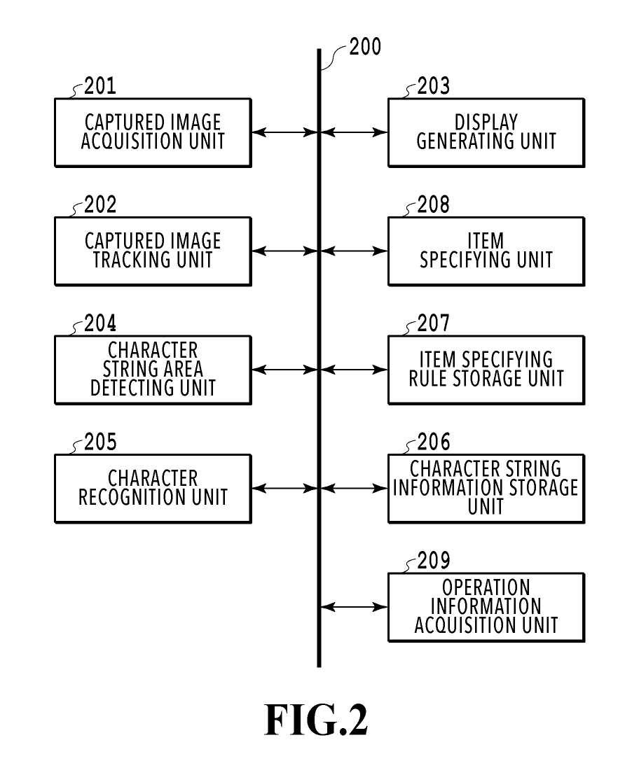

FIG. 2 is a diagram showing an exemplary configuration of function units in the mobile terminal 100. The mobile terminal 100 has a captured image acquisition unit 201, a captured image tracking unit 202, a display generating unit 203, a character string area detecting unit 204, a character recognition unit 205, and a character string information storage unit 206. The mobile terminal 100 further has an item specifying rule storage unit 207, an item specifying unit 208, and an operation information acquisition unit 209. The function units 201 to 209 shown in FIG. 2 are software components that are connected via a bus 200 of the software and input and output data to and from each other as necessary. The components perform communication with hardware to realize their functions. These are only examples, and the function units may be realized as software programs implemented as subroutines.

The captured image acquisition unit 201 acquires the captured images obtained by the imaging unit 101 at predetermined capture intervals. The captured images acquired by the captured image acquisition unit 201 will be inputted to the captured image tracking unit 202 and the display generating unit 203 as will be described later.

The captured image tracking unit 202 corrects the captured images that are acquired by the captured image acquisition unit 201 and inputted at predetermined capture intervals to be a state suitable for the processing in the character string area detecting unit 204 and the character recognition unit 205 as will be described later. In the present embodiment, the captured image tracking unit 202 has at least the following functions (1) to (3):

(1) A function of extracting four sides of a target document, which is a subject satisfying a certain condition, from captured images inputted from the captured image acquisition unit 201 at predetermined capture intervals.

(2) A function of storing the captured image as a reference image together with the extracted four sides, in a case where four sides are extracted according to the function (1).

(3) A function of performing distortion correction (e.g., trapezoid correction) on the captured image into a rectangle image corresponding to a document (hereinafter referred to as a document image) based on the reference image stored in the function (2) and the positions of four sides. (It should be noted that in a case of performing distortion correction on an image acquired by capturing the entire document (reference image), correction may be performed so that the detected four sides fit into a predetermined size (e.g., A4 size). In a case of performing distortion correction on an image acquired by capturing a portion of the document (partial captured image), a feature point of the partial captured image and a feature point of the reference image are compared, and correction may be performed so that the feature point of the partial captured image matches the corresponding feature point of the reference image after the distortion correction. Details will be described later.)

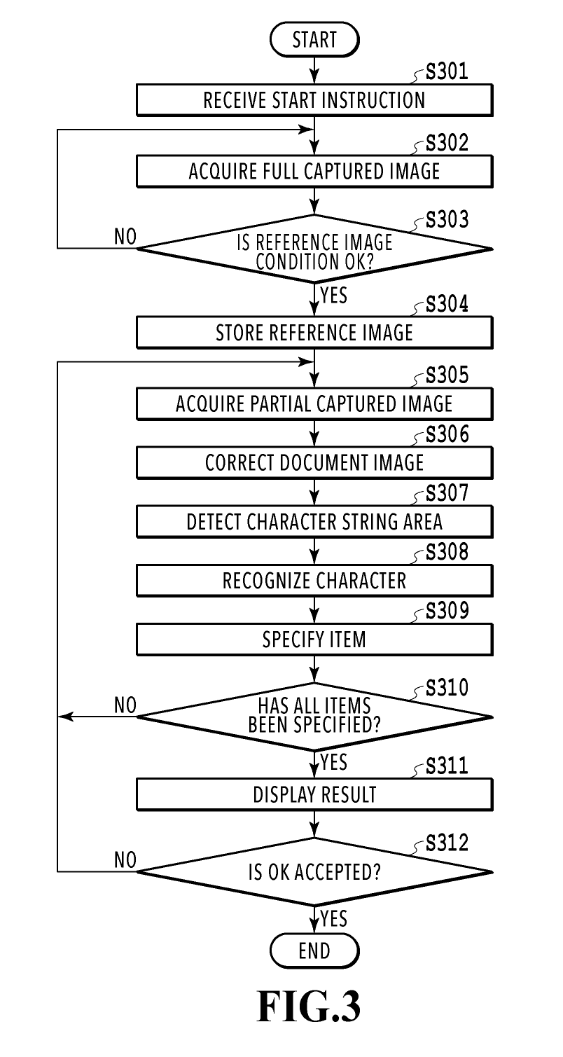

It should be noted that details and specific examples of the above functions will be described later as contents of processing performed by the captured image tracking unit 202 in the description of the processes in the flowchart of FIG. 3.

The display generating unit 203 generates a display image for a user interface. The generated display image is visualized by the display unit 102 of FIG. 1B.

Examples of the display image include a captured image inputted from the captured image acquisition unit 201. The display image generated by the display generating unit 203 and visualized by the display unit 102 is updated at intervals equivalent to capture intervals, thereby providing a function that serves as a system for the captured image acquisition unit 201, the display generating unit 203, and the like to allow a user to confirm a capturing content and state. The display image at this time may be an image corrected by the captured image tracking unit 202. Furthermore, information acquired from the character string information storage unit 206 and the item specifying unit 208, as will be described later, may be added or superposed.

The character string area detecting unit 204 detects a character string area including a character string that will be subjected to character recognition processing from a document image corrected by the captured image tracking unit 202 by using a known detecting technique. Information on the detected character string area is stored in the character string information storage unit 206.

The character recognition unit 205 performs known character recognition processing on the document image corrected by the captured image tracking unit 202 within the character string area stored in the character string information storage unit 206 to obtain a character recognition result composed of alignment of character codes.

The character string information storage unit 206 stores coordinate information (coordinates of the positions representing four corners of a character string area) on one or more character string areas detected by the character string area detecting unit 204 individually as character string information. Furthermore, the character string information storage unit 206 also stores the character recognition result generated by the character recognition unit 205 for each character string as well as the character string information. In addition, the character string information storage unit 206 determines whether the character string detected from a plurality of captured images and the character recognition result represent information on the same character string. The information on the same character string is integrated into one piece of character string information and stored.

The item specifying rule storage unit (condition storage unit) 207 stores an item specifying rule (condition) for specifying an item character string to be obtained. The item specifying rule may be stored in advance with all software of FIG. 2 in a storage unit (not shown) such as a ROM and HDD of the mobile terminal 100 or may be externally inputted through the operation information acquisition unit 209 (described later) while the mobile terminal 100 is operating. Examples of the item specifying rule include a character string condition rule and an item value output condition rule, which are the description of conditions to be described later in detail.

The item specifying unit 208 specifies an item character string to be obtained by evaluating the character string stored in the character string information storage unit 206 according to the item specifying rule stored in the item specifying rule storage unit 207. A result of the specification by the item specifying unit 208 may be notified to a user through the display generating unit 203 and the display unit 102 and also transmitted to the external server and the like through the communication unit 104, as necessary.

The above-described function units 201 to 209 are under the control of a CPU (not shown).

It should be noted that the flowchart of the present embodiment is processing performed by a mobile application (not shown) of the mobile terminal 100. In other words, the CPU loads, into a RAM, the programs of the mobile application relating the flowchart stored in the storage unit such as the ROM and HDD, and executes the programs, whereby the flowchart of the present embodiment is realized.

### <Operation of the Mobile Application>

Next, an example of operation of reading a character string on a subject by the mobile application of the mobile terminal 100 will be described with reference to FIG. 3. FIG. 3 is a flowchart of exemplary operation of the mobile terminal. Now, by way of example, description will be given of a series of work for a user to capture, by using the mobile terminal 100, a document of a paper business form which is a subject placed on a stage such as a desk and to read items listed in the business form. The symbol S as used herein refers to a step in the flowchart.

In S301, the operation information acquisition unit 209 receives activation of the mobile application (not shown) installed in the mobile terminal 100 as an instruction to start work by the user. At this time, in the work in S302 and the following steps, operation may be performed on the mobile terminal 100 such as an instruction relating to specifying the type of item to be obtained and the type of item specifying rule or selection of a setting file that specifies the types. In other words, the operation of specifying an item specifying rule (described later) relating to the paper business form which is a target subject may be performed on the mobile terminal 100. Once the instruction to start work is accepted, the mobile terminal 100 starts capturing a moving image by the imaging unit 101. The moving image captured by the imaging unit 101 is acquired by the captured image acquisition unit 201.

In S302, the entire document of the paper business form is captured by the imaging unit 101 of the mobile terminal 100 in a position separated from the paper business form as a subject. The captured image acquisition unit 201 acquires a full captured image obtained by capturing the entire document of the paper business form by the imaging unit 101. It should be noted that the full captured image is composed of a business form area and an area other than the business form area.

In S303, the captured image tracking unit 202 determines whether the full captured image acquired in S302 satisfies a reference image condition. Examples of the reference image condition include a condition that, by using the aforementioned function (1), four sides of the document satisfying a certain condition can be extracted from the full captured image. In a case where the reference image condition is satisfied, that is, in a case where four sides of the document satisfying a certain condition are extracted, the process proceeds to S304. In a case where the reference image condition is not satisfied, that is, in a case where it is determined that four sides are not extracted or the extracted four sides do not satisfy a certain condition, the process goes back to S302. Then, a next full captured image is acquired and the processing in S303 is performed again. In S303, it is also possible to make determination with a condition of a lower limit of the size of the business form area in addition to the reference image condition. Examples of the condition of a lower limit of the size of the business form area include a condition that the business form area is large enough to extract an image feature point and a condition that the business form area is larger than a predetermined size. Examples of the condition that “the business form area is larger than a predetermined size” include a condition that the size of the business form area defined by the extracted four sides is not less than a predetermined ratio as compared to the size of the entire captured image. It should be noted that in returning to S302, the mobile terminal 100 may display on the display unit 102 a method for capturing a full captured image that satisfies a reference image condition in the captured image. In this case, capturing operation by the user can be notified and operability can be increased.

It should be noted that a known method may be used for the aforementioned function (1) (i.e., the processing of extracting four sides of the document from the captured image). For example, straight line detecting processing such as the Hough transform is performed on an image obtained by extracting edges from a captured image. Based on the detected straight line group, a combination of four straight lines forming a quadrilateral is extracted. Then, in a case of identifying a combination of four straight lines where adjacent sides substantially form a right angle, a ratio of the adjacent sides is within a predetermined range, and an area of a quadrilateral is equal to or greater than a predetermined value, it may be determined that four sides satisfying a certain condition have been extracted. It should be noted that, in reality, capturing is not always performed in a state where the mobile terminal 100 completely and directly faces the document of the paper business form as a subject. Under the condition, the quadrilateral may not be a complete rectangle. The quadrilateral may include certain distortion such as a shape forming a rectangle through projective transformation, for example. Furthermore, instead of using the Hough transform, a connected component of edge pixels may be extracted, a linear component may be selected, and a set in collinear approximation may be processed in the same manner as the straight line group.

In S304, by using the aforementioned function (2), the captured image tracking unit 202 stores the full captured image acquired in the immediately preceding S302 as a reference image. Furthermore, coordinate information on the extracted four sides is stored in association with the reference image.

In S305, in a position close to the paper business form as a subject, a portion of the document of the paper business form is captured by the imaging unit 101 of the mobile terminal 100 and the captured image acquisition unit 201 acquires a partial captured image obtained by the imaging unit 101 capturing a portion of the document of the paper business form. The processing from S305 to S310 is loop processing, where acquiring a partial captured image and processing on the partial captured image are repeated.

In S306, by using the aforementioned function (3), the captured image tracking unit 202 corrects the partial captured image acquired in the immediately preceding S305 into a document image by using the reference image and the coordinate information on the four sides stored in S304. Accordingly, the partial captured image acquired in the immediately preceding S305 is associated with a corresponding area of the full captured image. Details of the correcting processing will be described below.

First, matching is performed between an image feature point extracted from the reference image (full captured image) and an image feature point extracted from the partial captured image. For the image feature points, Harris features serving as corner features and known feature points such as ORB and SIFT may be used. A known feature point detector may be used for the extracting. For the matching between image feature points, a matching level as features and a distance are used. By using the matching feature points, a homography matrix H₁ from coordinates of the partial captured image to coordinates of the reference image (coordinates of the full captured image) is calculated. More specifically, by removing incorrect matching by using the RANSAC method and solving simultaneous equations for obtaining a parameter of the homography matrix between sets of the feature points, a homography matrix Hi from the coordinates of the partial captured image to the coordinates of the reference image (the full captured image) is calculated. At this time, a known least squares method may also be used.

Next, a homography matrix H₂ is calculated for correcting the quadrilateral formed by the four sides extracted from the reference image in S303 to a document image (target image) which is a rectangle corresponding to a document. The homography matrix H₂ can be simply calculated according to simultaneous equations using correspondences among coordinate values of the four points. As used herein, the rectangle corresponding to a document refers to a rectangle having an aspect ratio equivalent to the document. The correction is intended for correction to an image suitable for the character recognition processing. The rectangle may have any size as long as it is suitable for the purpose. Assuming, for example, that the document has a A4 portrait size (210 mm×297 mm) and is corrected to a document image corresponding to 300 dpi, a 2480×3507 rectangle may be used.

By using a homography Hₘ=H₁×H₂ resulting from combining the homography matrices H₁, H₂ as calculated above, the partial captured image is corrected to a partial image of a corresponding part of the document image. For the correcting processing, known image projection transformation processing may be used. It should be noted that the partial captured image acquired in S305 does not always include four sides of the document of the paper business form to be captured. For instance, in a case where the mobile terminal 100 is placed close to the document of the paper business form to accurately recognize small characters in the document, a captured image may include an area other than the document of the paper business form. In this case, in the corrected document image, an area corresponding to the document in the captured image may be specified as a valid area, whereas an area other than the valid area may be specified as an invalid area. More specifically, in deforming an image having the same size as the captured image and in which every pixel has a pixel value 1 into a rectangular image by using the homography matrix Hₘ, an image is generated in which pixels of the area of the captured image other than a mapping area have a pixel value 0. By using this image as mask information, an area in the document image is determined to be valid or invalid.

In the description of the aforementioned S306, the image feature point extracted from the reference image and the homography matrix H₂ for deforming the four sides of the reference image into a document image are constant as long as the reference image is the same. Accordingly, they may be calculated and saved in S304 in which the reference image is stored, and they may be used in the processing in S306 each time.

Referring back to FIG. 3, in S307, the character string area detecting unit 204 performs detecting processing of a character string area on the document image corrected in S306 as an input. The detecting processing of a character string area will be described later in detail. Coordinates of the detected character string area are stored in the character string information storage unit 206. Coordinate information on the character string area is, for example, a list of coordinates of a rectangular area (coordinates of the positions representing four corners of a character string area) including the character string area.

At this time, the character string information storage unit 206 may not be empty. That is, there may be a case where the captured image was acquired in the past S305 and the character string information (hereinafter referred to as old character string information) detected from the document image obtained by correcting the captured image has already been stored in the character string information storage unit 206. In this case, the character string information storage unit 206 integrates the character string detected in the current S307 (hereinafter referred to as a current character string) into the old character string information as follows.

A position (rectangular coordinates) of the current character string and a position (rectangular coordinates) of the character string in the old character string information are compared. In a case where there are no overlap between the rectangular coordinates, the current character string is stored as new character string information. In a case where the rectangular coordinates partly overlap, it is assumed that change in the capture area has caused increase in the same character string area, and the old character string information is updated so as to include both the current character string and the overlapping character string. In a case where the current character string is included or substantially matches with the character string in the old character string information, the old character string information is not updated.

A known technique is used for the detection of a character string area in an image. Examples include the following method. First, a binary image to be an input is generated by binarizing pixels in a gray or color multivalued image. Binarization is performed with a threshold adaptively obtained based on brightness distribution of pixels in the image. Then, a connected component which connects a black pixel to be connected within the binary image by performing label processing is extracted. Of the extracted connected component, a character component estimated to represent a character in view of the size of a circumscribed rectangle or the like is further connected to a proximate character component, and a character string area is extracted.

It should be noted that the above-described detecting method is one of examples. More specifically, in obtaining a connected component, instead of generating a binary image, pixels having a similar brightness or similar color in a multivalued image may be connected. Alternatively, edge extraction may be performed to obtain a connected component from edge pixels to be connected. In addition, to enhance the speed of detecting processing, a connected component may be extracted from a document image which is subjected to reduction processing to detect a character string.

In S308, the character recognition unit 205 performs character recognition processing by using the document image corrected in S306 and the character string information stored in the character string information storage unit 206 as input data and updates the character string information in the character string information storage unit 206. More specifically, known character recognition processing is performed on an image within the area of the coordinates of the character string area included in the character string information on the document image, and a character recognition result composed of coordinates, a character code, and recognition reliability of each character is obtained. Based on the character recognition result, the character string information is updated. It should be noted that the character string information within the area determined to be invalid in S306 is not subjected to recognition processing. In a case where there are a plurality of pieces of character string information, character recognition processing is performed on each piece of character string information, and the character string information is updated. Specific contents of the updating processing will be described below.

The processing from S305 to S310 of FIG. 3 is loop processing. In the updating processing in S308, the character string information stored in the character string information storage unit 206 may or may not include a character recognition result (hereinafter referred to as a past character recognition result) stored or updated in the updating processing in the past S308.

In a case where there is no past character recognition result, as a character recognition result (hereinafter referred to as a current character recognition result) obtained in S308, information composed of coordinates, a character code, and recognition reliability (character recognition rate) of each character is stored in the character string information.

Meanwhile, in a case where there is a past character recognition result, the character string information storage unit 206 integrates the past character recognition result and the current character recognition result for each character, whereby a character recognition result in each piece of character string information is updated. More specifically, coordinates of the current character recognition result and coordinates of the past character recognition result are compared, and if there is no corresponding character recognition result, the current character recognition result is added. If there is a corresponding character recognition result, recognition reliability is compared between the current character recognition result and the past character recognition result. Then, the character recognition result stored in the character string information with a character code having a higher reliability is updated. That is, the character recognition result stored in the character string information with a character code having a higher reliability is stored as a candidate character string. The correspondence may be one character to one character or may be one character to N characters or N characters to M characters (N, M>1). In a case where reliability is compared for two or more characters, an average or maximum of a plurality of reliabilities may be used for comparison. Alternatively, instead of updating based on comparison between two current and past reliabilities, all pieces of the past character code information or a certain number of pieces of the past character code information may be stored, and a character code in the character string information may be updated based on majority from the past to the current. Information may be updated for each word that is a set of adjacent characters, not for each character. It should be noted that even after updating the character recognition result in the character string information, the past character recognition result remains stored in the character string information storage unit 206.

In S309, the item specifying unit 208 performs item specifying processing on the character string information stored in the character string information storage unit 206. That is, the item specifying unit 208 confirms the character string information stored in the character string information storage unit 206. Details of the item specifying processing will be described later. A result of the item specifying processing is a character string of an item value to be obtained, and the target and the specifying method are described in the item specifying rule stored in the item specifying rule storage unit 207.

In S310, in a case where the item specifying processing in S309 is completed, the process proceeds to S311. More specifically, in a case where all of the item character strings to be obtained described in the item specifying rule have been specified, the process proceeds to S311. In a case where all of the item character strings to be obtained described in the item specifying rule have not been specified yet, the process goes back to S305, and the processing from S305 to S310 is performed again. The processing from S305 to S310 is repeated until all of the item character strings to be obtained described in the item specifying rule have been specified.

In S311, the mobile terminal 100 displays the specified item character strings to be obtained on the display unit 102.

In S312, the display content of the item character strings to be obtained is confirmed by the user, and the operation information acquisition unit 209 accepts operation information by the user. In a case where the display content has no error, an instruction to allow completion of work is accepted, and the extracting flow of the character information is finished. On the other hand, in a case where the display content has an error, an instruction not to allow completion of work is accepted, and the process goes back to S305. Then, the processing from S305 to S310 is performed again. By continuously performing the detection of a character string area, the updating of character string information by character recognition, and the item specifying processing, a highly accurate character recognition result can be maintained across the entire document.

It should be noted that in the above description, the steps in the flowchart of FIG. 3 are sequentially performed in synchronous with captured image input. Some steps may be performed in asynchronous with the captured image input. For example, in a case of inputting 30 frames of captured images per second, the processing may be performed in the following manner. Specifically, the character string area detecting processing in S307 may be performed once in 30 frames, the character recognition processing in S308 may be performed once in 5 frames, and the item specifying processing in S309 may be performed only once in 20 frames. At this time, the captured images are always corrected into the document images in S306, and the character string information stored in the character string information storage unit 206, detected and recognized from the document images is integrated and managed so as to have the consistent document coordinates. Accordingly, throughout the detection of a character string area, character recognition, and item specifying processing, the character string information in the document can be handled regardless of at which timing in the loop from S305 to S310 of FIG. 3 the image is captured.

Furthermore, an inverse matrix Hₘ⁻¹ of the homography Hₘ calculated in S306 is a homography for transforming the document coordinates into the captured image. By using the homography Hₘ⁻¹, it is also possible to superpose the following character string information and character string on the captured image acquired in S305 to display the result on the display unit 102 of the mobile terminal 100. Examples of the character string information include character string information on a document coordinate system stored in the character string information storage unit 206. Examples of the character string include a character string of the item specifying result obtained in S309. In this case, since it is possible to know in real time what result of the character recognition processing or what result of the item specifying can currently be obtained, the user can operate the mobile terminal 100 so as to more efficiently specify a capture area of the mobile terminal 100. Furthermore, instead of completion determination in S310, the display of the result in S311 may be superposed on the captured image to continue capturing, and the loop from S305 to S312 may be repeated until the user explicitly instructs to complete work in S312.

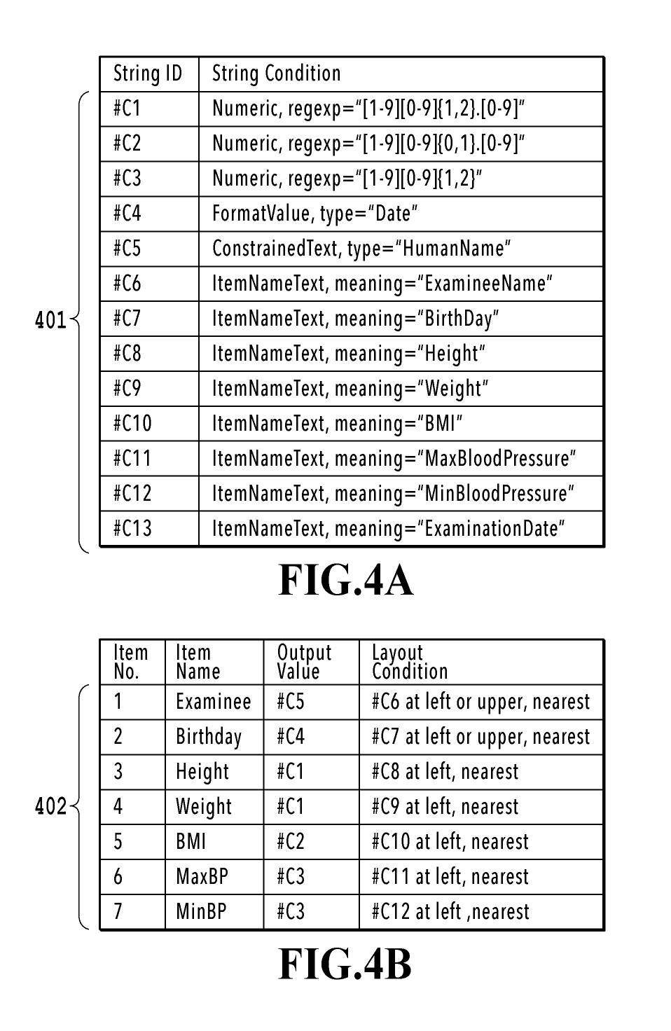

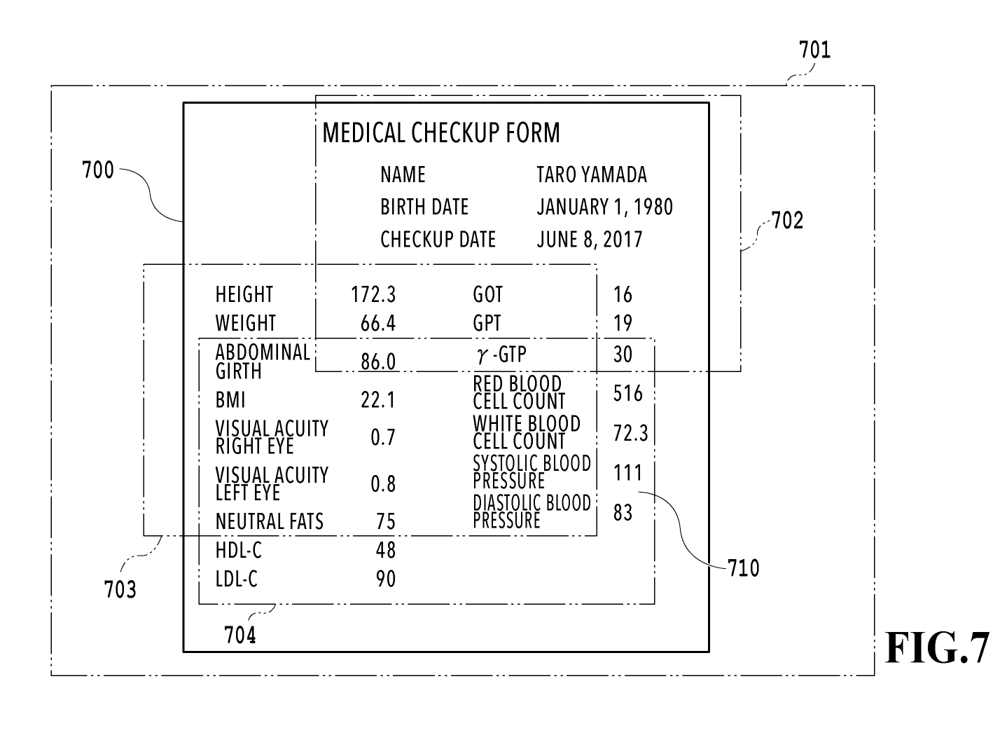

FIG. 4A and FIG. 4B show exemplary item specifying rules on an assumption of performing item specifying processing on a medical checkup form which is a paper business form as a subject shown in FIG. 7. The item specifying rule is a description of a processing content of the item specifying unit 208 and is classified into a character string condition rule 401 and an item value output condition rule 402. Examples of the character string condition rule 401 include string conditions for characters that define character codes forming a character string. Examples of the item value output condition rule 402 include the string conditions and layout conditions of character strings that define a layout position of a character string.

Each rule in a row of the character string condition rule 401 of FIG. 4A is composed of a pair of an ID and a condition description. In the present embodiment, in the condition description ID=#C1, “Numeric” means that a character string is a numeric character string, and “regexp=” . . . “” means that a character string satisfies a specified regular expression. More specifically, a numeric character string consisting of 2 to 3 digits beginning with the number other than 0 and one digit to the right of the decimal point satisfies the condition #C1. Likewise, a numeric character string consisting of 1 to 2 digits beginning with the number other than 0 and one digit to the right of the decimal point satisfies the condition #C2. An integer character string consisting of 2 to 3 digits beginning with the number other than 0 without a digit to the right of the decimal point satisfies the condition #C3. The condition #C4 is a standard character string of a date type. For instance, “January 1, 2017,” “January 1, Heisei 29,”“2017/1/1,” “Jan 1, 2017,” and the like all apply to this. In rule evaluation processing which will be described later, the date type character strings are internally defined as a regular expression pattern, and if there is any matching, it is determined that the condition is satisfied. The condition #C5 is a constrained character string of a human name type. Assuming that the medical checkup is targeted for the Japanese, a character string consisting of about 2 to 10 digits excluding the numbers and symbols that are inappropriate as a human name character applies to this. A general character string described as an item name for the meaning of an examinee name, i.e., “Examinee Name,” “Name,” and the like, applies to the condition #C6. In the rule evaluation processing described later, a word dictionary including variations of the descriptions is prepared, and if there is any matching, it is determined that the condition is satisfied. Likewise, character strings of general item names meaning a birth date, a height, a weight, BMI, a systolic blood pressure, a diastolic blood pressure, and a checkup date apply to the conditions #C7 to #C13.

Each rule in a row of the item value output condition rule 402 of FIG. 4B is composed of an item number, a distinct name for an item, a character condition of an output item value, and a layout condition for each item to be obtained. For instance, the item No. 1 is an examinee name, and the string condition of an output item value is #C5, i.e., a character string satisfying a condition of a human name type. The layout condition “#C6 at left” means that #C6, i.e., an item name character string corresponding to the examinee name, is located at the left of or above the output character string. The layout condition “nearest” means that, in a case where a plurality of output character strings satisfy the layout condition, the output character string located nearest to the item in the output condition is selected. That is, of the character strings satisfying a condition of a human name type, a character string in which an item name character string corresponding to the examinee name is located at the left of or above the character string and which is located at the nearest is to be outputted. The item No. 2 is an item of a birth date, and of the character strings satisfying #C4, i.e., a condition of a date type, a character string in which an item name character string corresponding to the birth date is located at the left of or above the character string and which is located at the nearest is to be outputted. Likewise, as for the item Nos. 3 to 7 as well, a character string that satisfies the string condition for the character for each output item value and a character string in which a specified item name is located at the left of the character string and which is located at the nearest is to be outputted.

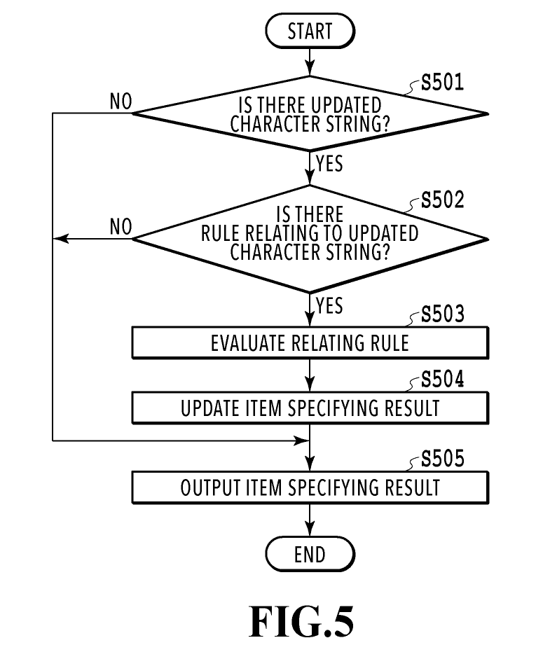

Hereinafter, with reference to the flowchart of FIG. 5, description will be given of the content of the item specifying processing performed by the item specifying unit 208 in S309 of FIG. 3 in a case where the item specifying rule shown in FIG. 4A or FIG. 4B is specified.

In S501, it is determined whether a character string in updated character recognition information (hereinafter referred to as an updated character string) has been stored in the character string information storage unit 206 in the processing in the aforementioned S308 since the last item specifying processing. That is, it is determined whether an updated character string (candidate character string) is stored in the character string information storage unit 206 in S308 in the last loop processing. In a case where an updated character string is stored, the process proceeds to S502. In a case where an updated character string is not stored, the process proceeds to S505.

In S502, it is determined whether the item specifying rules stored in the item specifying rule storage unit 207 relate to or do not relate to the updated character string determined in S501. In this example, the rule relating to the updated character string determined in S501 is determined with respect to both the character string condition rule 401 and the item value output condition rule 402. As a result of the determination, in a case where there is a relating rule, the process proceeds to S503. In a case where there is no relating rule, the process proceeds to S505.

For example, as for the character string condition rule 401, examples of the rules relating to the updated character string will be described below. For instance, a string of character codes for the updated character string is composed of only numbers. In this case, in the character string condition rule 401, #C1, #C2, and #C3 which include numeric string conditions are determined to be the relating rules. In addition, in a case where a numerical value of the updated character string consists of two digits and one digit to the right of the decimal point, only #C1 and #C2 are determined to be the relating rules. In a case where a numerical value of the updated character string consists of an integer, only #C3 is determined to be the relating rule. As for the other character string condition rules #C4 to #C13, it is difficult to determine which rules relate to the updated character string without actually performing the rule evaluation processing to determine whether each condition is satisfied. Instead, by defining in each condition a rule that can be definitely determined not to be satisfied through simple processing, such as a rule that a character string includes an Arabic numeral and a rule that the number of characters in a character string goes beyond a predetermined number, it may be determined whether the rules relate to or do not relate to the updated character string by using these rules.

As for the item value output condition rule 402, examples of the rules relating to the updated character string will be described below. For instance, in a case where a character code for the updated character string is an integer of two digits, as described above, only #C3 is determined to be the relating rule in the character string condition rule 401. As a result, in the item value output condition rule 402, it is determined that only the item output conditions of the item Nos. 6 and 7 which include #C3 in the output value or the layout condition are determined to be the rules relating to the updated character string. In other words, in the processing on the item value output condition rule, of the character string condition rules, rules corresponding to the rules that have been determined to relate to the updated character string are determined to relate to the updated character string.

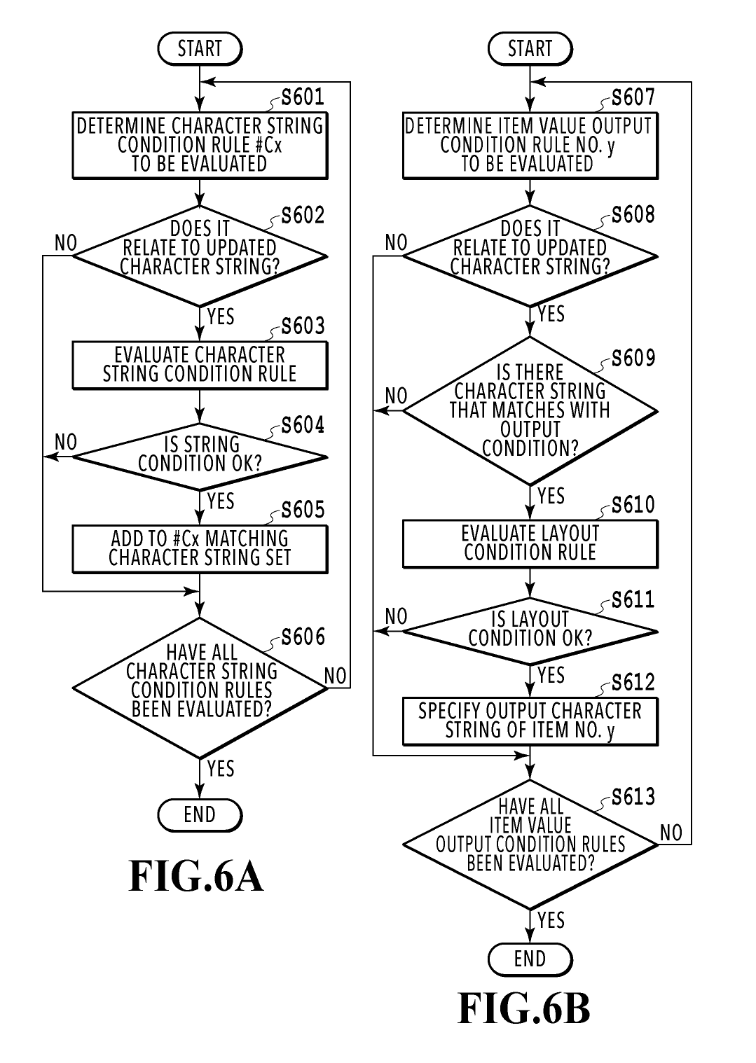

In S503, evaluation processing is performed on the character string condition rule determined to relate to the updated character string in S502. Details of the processing performed in S503 will be described with reference to the flowchart of FIG. 6A.

The processing from S601 to S606 in FIG. 6A is loop processing repeated for each rule described in the character string condition rules. Hereinafter, description will be given on an assumption that x^{th} character string condition rule #Cx is under the processing in x^{th} loop processing.

In S601, the item specifying unit 208 determines the character string condition rule #Cx to be evaluated (hereinafter referred to as an evaluation target character string condition rule) from the character string condition rules associated with the partial captured image acquired in S305 and the reference image stored in S304. It should be noted that in this example, the example of determining the evaluation target character string condition rule according to the order of numbers (#1, #2, . . . , #13) will be described, and the way of determination is not limited to this. The determination may be not in particular order.

In S602, it is determined whether the evaluation target character string condition rule #Cx determined in S601 relates to the updated character string (candidate character string). In a case where the evaluation target character string condition rule #Cx relates to the updated character string, the process proceeds to S603. In a case where the evaluation target character string condition rule #Cx does not relate to the updated character string, the processing on the evaluation target character string condition rule #Cx from S603 to S605 is skipped and the process proceeds to S606. That is, in a case where the evaluation target character string condition rule #Cx is a relating rule determined in S502, the process proceeds to S603. In a case where the evaluation target character string condition rule #Cx is not a relating rule determined in S502, the processing on the evaluation target character string condition rule #Cx is skipped and the process proceeds to S606.

In S603, the evaluation target character string condition rule #Cx is evaluated with respect to the updated character string (candidate character string). More specifically, processing is performed to determine whether the updated character string satisfies a condition described in the string condition in the evaluation target character string condition rule #Cx.

In S604, in a case where there is an updated character string that satisfies the string condition in the evaluation target character string condition rule #Cx in the evaluation in S603, the process proceeds to S605. In a case where there is no updated character string that satisfies the string condition in the evaluation target character string condition rule #Cx, the process proceeds to S606.

In S605, the updated character string that satisfies the string condition in the evaluation target character string condition rule #Cx is added to a #Cx matching character string set. The #Cx matching character string set is a list of updated character strings that match the evaluation target character string condition rule #Cx. In this example, in a case where there already exists a character string whose coordinates match with the coordinates of the updated character string in the #Cx matching character string set and only the character code information as recognized is different, only the character code information is updated. In a case where there exists no updated character string, it is added as a new character string. After S605, the process proceeds to S606, and it is determined whether all of the character string condition rules have been evaluated. In a case where there is an unevaluated character string condition rule, the process goes back to S601, and the processing from S601 to S606 is performed. In a case where there is no unevaluated character string condition rule, the evaluation processing on the character string condition rule in FIG. 6A is finished.

Referring back to FIG. 5, in S504, with respect to the result of the evaluation of the character string condition rule performed in S503, the item value output condition rule is evaluated, and the item specifying result is updated. Details of the processing performed in S504 will be described with reference to the flowchart of FIG. 6B.

The processing from S607 to S613 in FIG. 6B is loop processing repeated for each rule described in the item value output condition rule. Hereinafter, description will be given on an assumption that the rule of the item number y is under the processing in the loop processing.

In S607, an item value output condition rule No. y to be evaluated is determined. It should be noted that in this example, description will be given on the assumption of evaluating the item value output condition rule No. y to be evaluated (determined according to the order of numbers 1, 2, . . . , 7) in y^{th} loop processing, and the way of evaluation is not limited to this. The evaluation target may be determined not in particular order.

In S608, it is determined whether the item value output condition rule No. y to be evaluated (hereinafter referred to as an evaluation target item value output condition rule) determined in S607 is a rule relating to the updated character string (candidate character string). In a case where the character string condition rule corresponding to the matching character string set to which the updated character string is added in the processing in S605 is included in the item value output or the layout condition described in the rule of the item No. y, it is determined that the evaluation target item value output condition rule No. y is a relating rule. Meanwhile, in a case where the character string condition rule corresponding to the matching character string set to which the update of the character code information is added in the processing in S605 is included in the item value output or the layout condition described in the rule of the item No. y, it is determined that the evaluation target item value output condition rule No. y is a relating rule.

In a case where it is determined that the evaluation target item value output condition rule No. y is a relating rule, the process proceeds to S609. In a case where it is determined that the evaluation target item value output condition rule No. y is not a relating rule, the processing from S609 to S612 which is the processing performed on the evaluation target item value output condition rule No. y is skipped and the process proceeds to S613. That is, in a case where the evaluation target item value output condition rule No. y is determined to be a relating rule in S502, the process proceeds to S609. In a case where the evaluation target item value output condition rule No. y is determined not to be a relating rule in S502, the processing on the evaluation target item value output condition rule No. y is skipped and the process proceeds to S613.

In S609, it is determined whether there is a character string that matches with the output condition of the item No. y. More specifically, in a case where the output condition is #Ci, it is determined whether the #Ci matching character string set includes a character string. In a case where the #Ci matching character string set includes a character string, the process proceeds to S610. In a case where the #Ci matching character string set does not include a character string, the processing from S610 to S612 is skipped and the process proceeds to S613.

In S610, the evaluation processing is performed on the layout condition of the item No. y. More specifically, on every combination of a character string included in the matching character string set of the character string condition rule #Cj described in the layout condition and a character string included in the #Ci matching character string set of the item value output condition, it is evaluated whether a positional relation satisfies the condition described in the layout condition. After evaluating the layout condition, the process proceeds to S611.

In S611, in a case where there is a combination that satisfies the layout condition as a result of the evaluation processing in S610, the process proceeds to S612. In a case where there is no combination that satisfies the layout condition, S612 is skipped and the process proceeds to S613.

In S612, a matching character string of the item value output condition in the combination that satisfies the layout condition determined in S611 is specified as an output character string of the item No. y. In a case where a plurality of combinations satisfy the layout condition, both character strings may be outputted as candidates for the output character string or one matching level of the layout condition may be outputted from relative evaluation. After specifying the output character string, the process proceeds to S613.

In S613, it is determined whether all of the item value output condition rules have been evaluated. In a case where there is an unevaluated item value output condition rule, the process goes back to S607, and the processing from S607 to S613 is determined. In a case where there is no unevaluated item value output condition rule, the evaluation processing on the item value output condition rule in FIG. 6B is finished.

Referring back to FIG. 5, in S505, the output character string of the item number specified in S504 is outputted as an item specifying result, and the processing in the flowchart of FIG. 5 is finished. Meanwhile, in a case where the condition in S501 or S502 is not satisfied, and the processing from S503 to S504 is skipped, the item specifying result at the start of the present flowchart is outputted as it is. In a case where the condition in the detailed processing in S503 or S504 is not satisfied as well, the item specifying result at the start of the present flowchart is outputted as it is.

Next, description will be given of an actual example of item reading processing according to the flowcharts of FIG. 3 to FIG. 6 to be performed on a document shown in FIG. 7, as a work example for a user to read necessary items from the document of the medical checkup form by using the mobile terminal 100 of the present invention. In this example, as the item specifying rules, the character string condition rule 401 of FIG. 4A and the item value output condition rule 402 of FIG. 4B will be used.

A document 700 of FIG. 7 is an example of the medical checkup form used in the present description. After instructing the mobile terminal 100 of the start of work, while checking the display content of the display unit 102, the user captures the document 700 within a capture area 701 where four sides of the document 700 fit. At the same time, the captured image acquisition unit 201 of the mobile terminal 100 acquires the full captured image of the document 700. This processing corresponds to the loop processing from S302 to S303 of FIG. 3. In a case where the mobile terminal 100 extracts four sides that satisfy a certain condition, the process proceeds to S304, and the full captured image acquired in S302 is stored as the reference image.

Next, the user performs the item reading work while placing the mobile terminal 100 close to the document 700 to partially capture the document 700 so that the mobile terminal 100 can accurately recognize the characters in each item of the business form. This processing corresponds to the loop processing from S305 to S310. First, the user captures the document 700 within the capture area 702. The captured image acquired in S305 (partial captured image) is corrected to the document image in S306, and the coordinates of the character string area detected in S307 are stored in the character string information storage unit 206.

In S308, character recognition processing is performed on the character string area of the document image under the processing, to obtain a character recognition result. In this example, sixteen character strings are obtained as follows. The character strings “Medical Checkup Form,” “Name,” “Taro Yamada,” “Birth Date,” “January 1, 1980,” “Checkup Date,” and “June 8, 2017” are obtained. Furthermore, the character strings “172.3,” “GOT,” “16,” “66.4,” “GPT,” “19,” “86.0,” “γ-GTP,” and “30” are obtained. Each character string is stored as the updated character string in each piece of the character string information in the character string information storage unit 206. To show that the character string is the updated character string, a flag representing the update is given to each piece of character string information.

It should be noted that the above character recognition processing may be performed on the same document image immediately after the detecting processing of the character string area or may be performed on a corrected document image from another captured image while repeating the loop. As described above, this is because, through the document image correcting processing in S306, the character string in the valid area of the document image is processed to always have the same coordinates of the document coordinate system.

In S309, the item specifying processing is performed according to the processing in the flowchart of FIG. 5. In S501, at this point, all pieces of information stored in the character string information storage unit 206 are the updated character strings, and thus the process proceeds to S502. In S502, since the updated character string includes a numeric character string, it is determined that the updated character string relates to at least the rules #C1 to #C3 in the character string condition rule 401, and the process proceeds to S503.

In S503, by the processing in the flowchart of FIG. 6A, evaluation of the updated character string is performed for each rule in the character string condition rule 401 of FIG. 4A. For example, in the loop for processing the rule #C1, the character string condition rule #1 is determined in S601, and it is determined that the updated character string of the numeric value relates to the rule #C1 in S602. The process proceeds to S603 to evaluate the updated character string. In S604, it is determined that the evaluation result satisfies the string condition, and the process proceeds to S605, where three character strings “172.3,” “66.4,” and “86.0” are added to the #C1 matching character string set. Likewise, “66.4” and “86.0” are added to the #C2 matching character string set, and “16,” “19,” and “30” are added to the #C3 matching character string set. To the #C4 matching character string set, the date type character strings “January 1, 1980” and “June 8, 2017” are added. To the #C5 matching character string set, all pieces of the updated character strings, which do not include a number in this example, are added as the character strings of a human name type. To the matching character string sets of #C6, #C7, and #C13, “Name,” “Birth Date,” and “Checkup Date” are added, respectively.

In S504, according to the flowchart of FIG. 6B, the rules in the item value output condition rule 402 of FIG. 4B are processed with respect to the updated character string. For example, in the loop for processing the item No. 1, the item No. 1 is determined in S607, and in S608, it is determined whether the #C5 matching character string set of the string condition of the item output value or the #C6 matching character string set of the string condition serving as the layout condition has been updated. In this example, since both of the #C5 and #C6 matching character string sets have been updated, the process proceeds to S609. Then, for all of the character strings in the #C5 matching character string set, evaluation of the layout condition is performed in S610. In S611, in a case where the evaluation result satisfies the layout condition, the process proceeds to S612. More specifically, a character string, to the left side of which the character string included in the #C6 matching character string set is located, is selected from the #C5 matching character string set, and one having a smallest distance therebetween is selected. As a result, “Taro Yamada” is specified as the output character string of the item No. 1 in S612. Likewise, “January 1, 1980” is specified as the output character string of the item No. 2. At this point, nothing is specified for the rules of the item Nos. 3 to 6.

The result of the above item specifying processing in S309 is expressed by the item Nos. 1 to 6 to be obtained: the item No. 1 (examinee name) =“Taro Yamada,” the item No. 2 (birth date) =“January 1, 1980,” the item Nos. 3 to 6 unspecified. As a result, in S310, it is determined that the item specifying processing has not been completed, and the process goes back to S305. At this time, the specified item values are displayed on the display unit 102 of the mobile terminal 100. The user looks at the display and changes the capture area so as to include unspecified items.

Next, the user captures the document 700 within a capture area 703, and similarly obtains a character recognition result through the processing from S305 to S308. In this example, 21 character strings are obtained as follows. The character strings “Height,” “172.3,” “GOT,” “Weight,” “66.4,” “GPT,” “Abdominal Girth,” “86.0,” and “γ-GTP” are obtained. The character strings “BMI,” “22.1,” “Red Blood Cell Count,” “Visual Acuity Right Eye,” “0.7,” “White Blood Cell Count,” “Visual Acuity Left Eye,” “0.8,” “Systolic Blood Pressure,” “Neutral Fats,” “75,” and “Diastolic Blood Pressure” are obtained. Among these character strings, in “172.3,” “GOT,” “66.4,” “GPT,” “86.0,” and “γ-GTP,” there is no change in the coordinates and the recognized character codes from the character string information acquired in the capture area 702. Therefore, other than the above, the following 15 character strings are stored as the updated character strings (candidate character strings) in the character string information storage unit 206. The character strings “Height,” “Weight,” “Abdominal Girth,” “BMI,” “22.1,” “Red Blood Cell Count,” “Visual Acuity Right Eye,” “0.7,” “White Blood Cell Count,” “Visual Acuity Left Eye,” “0.8,” “Systolic Blood Pressure,” “Neutral Fats,” “75,” and “Diastolic Blood Pressure” are stored as the updated character strings in the character string information storage unit 206.

In S309, the item specifying processing is performed on each updated character string. Since the updated character string includes numeric character strings, the process proceeds to the evaluation processing on the relating rules. By evaluating the character string condition rule 401, the #C1 matching character string set is updated to “172.3,” “66.4,” “86.0,” and “22.1.” The #C2 matching character string set is updated to “66.4,” “86.0,” and “22.1.” The #C3 matching character string set is updated to “16,” “19,” “30,” and “75.” Furthermore, to the #C8, #C9, #C10, #C11, and #C12 matching character string sets, respectively, “Height,” “Weight,” “BMI,” “Systolic Blood Pressure,” and “Diastolic Blood Pressure” are added. Next, for the evaluation of the item value output condition rule 402, the rules of the item Nos. 3 to 6 including the string condition of the updated matching character string set are processed. As a result, the item No. 3 (height)=“172.3,” the item No. 4 (weight)=“66.4,” the item No. 5 (BMI)=“22.1” are specified as the output character strings. Since no character string satisfies the layout condition, the item Nos. 6 and 7 are not specified. In S310, it is determined that the item specifying processing has not been completed, and the process goes back to S305.

Furthermore, the user captures the document 700 within a capture area 704, and similarly obtains a character recognition result through the processing from S305 to S308. In this example, 24 character strings are obtained as follows. The character strings “Abdominal Girth,” “86.0,” “γ-GTP,” “30,” “BMI,” “22.1,” “Red Blood Cell Count,” “516,” “Visual Acuity Right Eye,” “0.7,” “White Blood Cell Count,” “72.3,” “Visual Acuity Left Eye,” “0.8,” “Systolic Blood Pressure,” “III,” “Neutral Fats,” “75,” “Diastolic Blood Pressure,” and “83” are obtained. Furthermore, the character strings “HDL-C,” “48,” “LDL-C,” and “90” are obtained. It should be noted that the Roman numeral “III” is an error in the character recognition processing performed on a character string 710 of FIG. 7, and a correct character string is an Arabic numeral “111.” At this point, there is no correction system and the Roman numeral “III” is directly stored in the character string information storage unit 206. Except for the character string that has no update of the character code in the recognition result, “30,” “516,” “72.3,” “III,” “83,” “HDL-C,” “48,” “LDL-C,” and “90” are the updated character strings.

In S309, the item specifying processing is performed on each updated character string. Since the updated character string includes a numeric character string, the process proceeds to the evaluation processing on the relating rules. By evaluating the character string condition rule 401, the #C1 matching character string set is updated to “172.3,” “66.4,” “86.0,” “22.1,” and “72.3.” The #C2 matching character string set is updated to “66.4,” “86.0,” “22.1,” and “72.3.” The #C3 matching character string set is updated to “16,” “19,” “30,” “75,” “516,” “83,” “48,” and “90.” Next, for the evaluation of the item value output condition rule, the rule of the item No. 7 relating to the character string condition rule of the updated matching character string set is processed. As a result, the item No. 7 (diastolic blood pressure)=“83” is specified as the output character string. As for the item No. 6, since a character string that should originally be an item value is stored as “III” due to the aforementioned character recognition error and does not match with the string condition #C3, no character string satisfies the layout condition, and no item is specified. Accordingly, in S310, it is determined that the item specifying processing has not been completed, and the process goes back to S305.

It should be noted that the user continues capturing the document 700 within the capture area 704 and the mobile terminal 100 repeats the processing from S305 to S310. During that time, the above character strings continue to be obtained as a result of the character recognition processing performed on the document image generated by correcting the acquired captured image, and there is no updated character string, and evaluation of the item specifying rule is not performed, either. With the passage of time, from the document image at some point generated by correcting the captured image acquired in S305, a recognition result “111” which is an Arabic numeral is obtained with respect to the character string 710. As a result, the updated character string becomes “111” which is an Arabic numeral, and through the evaluation of the character string condition rule 401, the #C3 matching character string set is updated to “16,” “19,” “30,” “75,” “516,” “83,” “48,” “90,” and “111.” Then, as an item value output character string that satisfies the layout condition of the item No. 6 in the item value output condition rule 402, “111,” which is an Arabic numeral, is specified. Accordingly, the item No. 6 (systolic blood pressure)=“111” are specified as output character strings, individually. In this manner, if all of the output character strings of the obtained item values from item Nos. 1 to 7 are specified, the process proceeds from S310 to S311. The user checks the display of the character strings (S312), and in a case where the display of the character strings shows OK, the mobile terminal 100 accepts the instruction of OK by the user and completes the work.

In the above description of the operation example, based on the description of the item specifying rule stored in the item specifying rule storage unit 207, the item specifying unit 208 of FIG. 2 discriminates between rules relating to and rules not relating to the character string information updated based on the acquired captured image. More specifically, in each of S502 of FIG. 5, S602 of FIG. 6A, and S608 of FIG. 6B, it is determined whether the item specifying rule relates to the updated character string, and the evaluation processing is not performed on a rule not relating to the updated character string. As a result, even in a case where the acquired character string information is progressively added and partially updated in the character recognition processing for a moving captured image as an input, it is possible to perform necessary rule evaluation processing on the updated character string and reduce unnecessary rule evaluation processing. For example, in the above example, in a case where only a character code of a recognition result of the character string 710 of FIG. 7 is updated, only #C1 to #C3 which have numeral value conditions as the character string condition rules are evaluated. Since the evaluation result is an integer and only the matching character string set of the character string condition rule #3 is updated, only the item value output condition rules of the item Nos. 6 and 7 in which the string condition #C3 is an output condition is evaluated. If the determination is not performed, every time the character recognition result is updated based on the input of the moving captured image, the evaluation processing is performed on every rule. The processing time depends on the type of item to be obtained and the number of character strings in the document. If there are many types and character strings, a frame rate of moving image processing decreases due to the increase in the evaluation processing time or much time is require for the user to confirm the recognition result. As a result, operability of the operation of reading a business form by the mobile terminal 100 may decrease.

As described above, according to the present embodiment, in the mobile terminal which is a hand-held device for capturing a document of a business form with a camera by a user to perform item reading processing, the character recognition processing is performed while partially capturing the document of the business form through an input of a moving image. At this time, the reference image is specified by the captured image and four sides of the document are extracted, and based on them, the captured images of different capture areas are converted (corrected) into document images that always have the same coordinate system. Then, character strings detected and recognized from difference document images are added and updated as a set of character string information extracted from each part of the document and the character string information is stored. On an update part of the character string information, by evaluating the predetermined item specifying rule, a character string of an item to be obtained is specified. Accordingly, while confirming the information on the specified item displayed by the mobile terminal, the user repeats partially capturing at a position close to the document so as to secure accuracy of the character recognition, thereby easily performing operation of progressively reading a plurality of items. In the item specifying rule evaluation processing, only the rule relating to the character string updated by the recognition on the moving image input is specified and the evaluation processing is performed. As a result, it is possible to reduce unnecessary rule evaluation and avoid increase in an evaluation processing load and an evaluation processing time, and thus even in a case where there are many items to be obtained and many character strings in the document, it is possible to provide reading operation that does not impair operability. Accordingly, while reducing a processing load, it is possible to efficiently obtain a favorable character recognition result of a subject.

### Second Embodiment

Next, description will be given on an aspect, as a second embodiment, that the item value output condition rule was specified in the past, and a rule that does not require reevaluation is specified from the layout of the updated character string to skip the evaluation processing. It should be noted that description of the content that is in common with the first embodiment, such as the flow of control of item reading processing of a subject, will be omitted. Description will be given mainly of the evaluation processing of the item value output condition rule, which is a feature of the present embodiment.

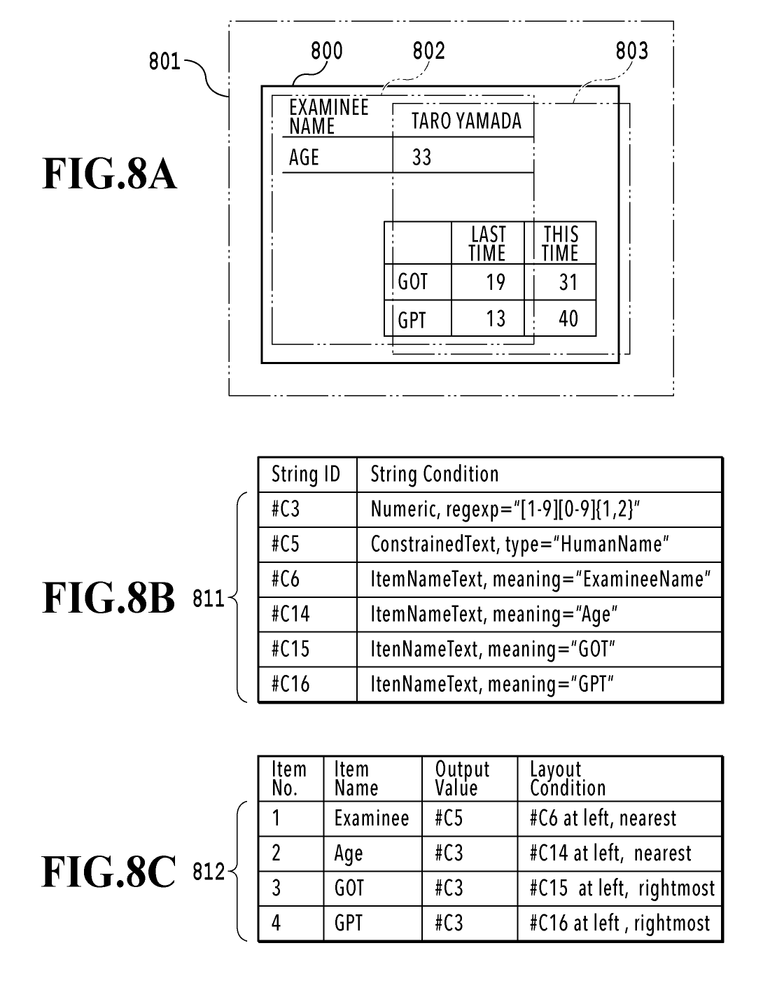

FIG. 8A is a diagram showing an example of a paper business form and a capture area subjected to item reading operation using the mobile terminal 100 in the second embodiment of the present invention. FIG. 8B and FIG. 8C are exemplary item specifying rules used in the present embodiment. A document 800 as a subject is an example of a document of a business form including an examination result of liver function measurements. Capture areas 801 to 803 are examples of different capture areas in capturing the document 800.

A character string condition rule 811 of FIG. 8B and an item value output condition rule 812 of FIG. 8C are examples of item specifying rules for reading a predetermined item from the business form of FIG. 8A. In the character string condition rule 811, the rules #C3, #C5, and #C6 have the same meanings as those of the rules #C3, #C5, and #C6 in the character string condition rule 401 of FIG. 4A. #C14 applies to a character string meaning age, #C15 applies to a character string meaning a liver function level GOT, and #C16 applies to a character string meaning a liver function level GPT. Of the layout conditions in the item value output condition rule 812, “rightmost,” which does not appear in FIG. 4B, means that the rightmost character string is outputted in a case where there are a plurality of output character strings that satisfy the layout condition. This is a rule on an assumption that, as the known information on the target business form, an output character string is located on the right side among a plurality of item values to be obtained.

Hereinafter, an operation example of the mobile terminal 100 in the item reading work for the document 800 of FIG. 8A will be described. It should be noted that among the contents of the configuration and the processing steps of the mobile terminal 100, description of FIG. 2, FIG. 3, FIG. 5, and FIG. 6A is the same as that in the first embodiment.

After instructing the mobile terminal 100 of the start of work, first, the user captures an image of the document 800 within a capture area 801 where four sides of the document 800 fit. At the same time, the captured image acquisition unit 201 of the mobile terminal 100 acquires the full captured image of the document 800. This processing corresponds to the loop processing from S302 to S303 of FIG. 3. In a case where the mobile terminal 100 extracts four sides that satisfy a certain condition, the process proceeds to S304, and the full captured image acquired in S302 is stored as the reference image.

Next, the user performs the item reading work while placing the mobile terminal 100 close to the document 800 to partially capture the image of the document 800. This processing corresponds to the loop processing from S305 to S310. The user captures the document 800 within a capture area 802 and acquires an image (partial captured image) in S305. In S306, the captured image (partial captured image) is corrected to the document image. In S307, a character string area is detected, and the coordinates of the character string area are stored in the character string information storage unit 206.

In S308, character recognition processing is performed on the character string area of the document image. As a character recognition result, the character strings “Examinee Name,” “Taro Yamada,” “Age,” “33,” “Last Time,” “GOT,” “19,” “GPT,” and “13” are obtained. Each character string is the updated character string.

In S309, the item specifying processing is performed according to the flowchart of FIG. 5. In the present embodiment, as the item specifying rules, the character string condition rule 811 of FIG. 8B and the item value output condition rule 812 of FIG. 8C are used.

First, according to the flowchart of FIG. 6A, if the character string condition rule 811 of FIG. 8 is evaluated with respect to the updated character string, to the #C3 matching character string set, “33,” “19,” and “13” are stored. To the #C5 matching character string set, the character strings “Examinee Name,” “Taro Yamada,” “Age,” and “Last Time,” which include two or more characters not including an alphanumeric character in this example, are stored as the character strings of a human name type. To the #C6 matching character string set, “Examinee Name” is stored. To the #C14 matching character string set, “Age” is stored. To the #C15 matching character string set, “GOT” is stored. To the #C16 matching character string set, “GPT” is stored.

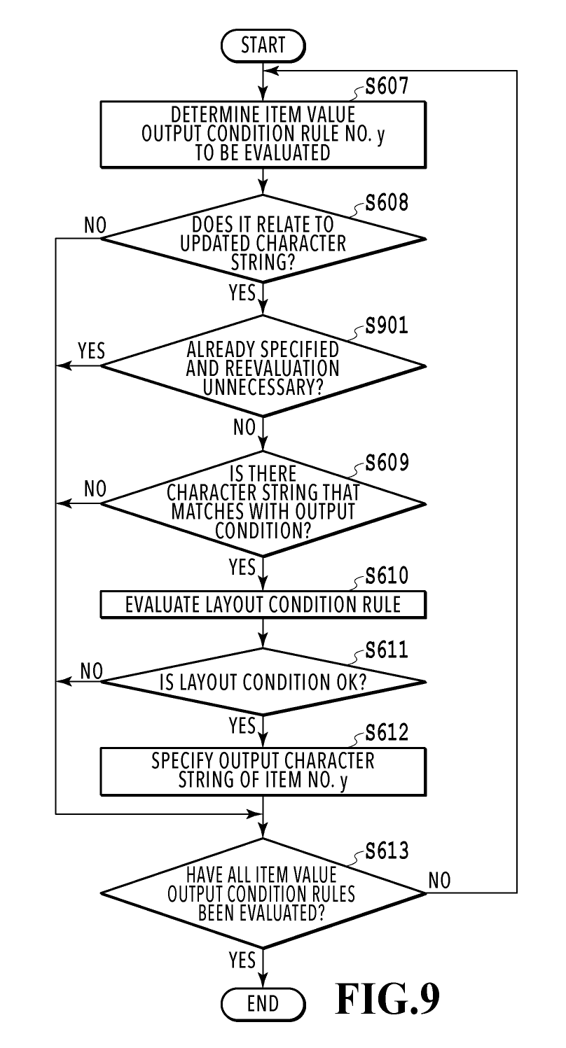

Next, the rules in the item value output condition rule 812 of FIG. 8C are evaluated with respect to the updated character string. In the present embodiment, according to the flowchart of FIG. 9, the evaluation processing of the item value output condition rule is performed. It should be noted that as for S607 to S613 in the flowchart of FIG. 9, description will be omitted since they are the same steps of the same numbers in the flowchart of FIG. 6B in the first embodiment. In S901, which is a difference from FIG. 6B, it is determined whether an output value for the item number under processing has already been specified. In a case where an item is not specified or in a case where an item has already been specified, it is determined whether further reevaluation is necessary. In a case where the reevaluation is not necessary, the processing from S609 to S612 is skipped and the process proceeds to S613. In a case where an item has already been specified but reevaluation is necessary, the process proceeds to S609. First, in the present embodiment, in the case of the first processing in the flowchart of FIG. 9, since none of the items have been specified, the process proceeds to S613. It should be noted that details of the processing of determining whether reevaluation is necessary will be described later.

In the rule of the item No. 1, the character string “Taro Yamada” is specified as an output result of the item value, and in the rule of the item No. 2, the character string “33” is specified as an output result of the item value. Since this processing is the same as the processing in the first embodiment, the description will be omitted. In the rule of the item No. 3, “19” that is the only character string satisfying the layout condition in the #C3 matching character string set is specified. In the rule of the item No. 4, “13” is specified.

Through the above-described item specifying processing in S309, output character strings for all of the item Nos. 1 to 4 to be obtained are specified. However, since a user, who has confirmed the display, actually wishes to obtain liver function measurements in the “This time” column on the right side of the table, instead of the “Last Time” column that has already been captured, the user moves the mobile terminal 100 and captures the capture area 803 that includes the measurements in the “This time” column.

The updated character strings obtained from the captured image within the capture area 803 are “31” and “40.” By comparing the coordinates of the character string area obtained this time and the coordinates of the old character string area other than the updated character string stored in the character string information storage unit 206, it is recognized that all of the updated character strings are located on the right side of the old character strings. Then, in S901 of the flowchart of FIG. 9, it is determined that reevaluation is not necessary since the item value output was specified in the past and a rule where the layout condition includes “rightmost” is not relating. More specifically, the rule of the item No. 2 has already been specified as “33” that satisfies the string condition #C3 and is closest to the character string “Age” that matches with #C14. Even if there are more updated character strings on the right side of “33,” the evaluation result does not likely to change, and thus it is determined that reevaluation is not necessary. As a result, only the layout conditions of the item Nos. 3 and 4 are evaluated in S610. As a result, the output character string of the item No. 3 is “31” and the output character string of the item No. 4 is updated to “40” and outputted. The user, who has confirmed the display, determines that all of the target item values have been correctly read, and the work is completed.

As described above, according to the present embodiment, in the evaluation processing of the item specifying rule, only the rule relating to the updated character string through the recognition of the moving image input is specified and the evaluation processing is performed. At this time, a rule that does not require reevaluation is specified from the layout of the updated character string to skip the evaluation processing. As a result, it is possible to reduce unnecessary rule evaluation and avoid increase in an evaluation processing time, and thus even in a case where there are many items to be obtained and many character strings in the document, it is possible to provide reading operation that does not impair operability.

It should be noted that instead of a moving image, a still image may be used. The reference image may also be used which is stored in the character string information storage unit 206 before performing the reading operation of the character string on the subject. The updated character strings (candidate character strings) that apply to the same rule may individually be stored in a character string information storage unit. At least one of the string condition and the layout condition of the character string may be used to evaluate the updated character string (candidate character string).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, it is possible to efficiently obtain a favorable character recognition result of a subject while minimizing a processing load.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-220309, filed Nov. 15, 2017, which is hereby incorporated by reference wherein in its entirety.

What is claimed is:

1. An information processing apparatus comprising:
an acquisition unit configured to acquire a partial image acquired by capturing a portion of a subject including character strings;
a storage unit configured to store a candidate character string among character strings recognized in the partial image in association with a full image obtained by capturing the entire subject;
a specifying unit configured to specify a character string to be obtained by evaluating the candidate character string by using a condition relating to the candidate character string stored in the storage unit; and
a generating unit configured to generate a partial image of the subject, the partial image of the subject including the character string to be obtained that is specified by the specifying unit.

2. The information processing apparatus according to claim 1, wherein in a case where the candidate character string is evaluated to satisfy the condition, the specifying unit specifies the candidate character string as the character string to be obtained.

3. The information processing apparatus according to claim 1, wherein the condition includes a condition of a character string of the subject and a layout condition of a character string of the subject, and
the specifying unit uses at least one of the condition of a character string of the subject and the layout condition of a character string of the subject to evaluate the candidate character string.

4. The information processing apparatus according to claim 3, wherein in a case where a position of the candidate character string relates to the layout condition of the character string to be obtained that has already been specified, the specifying unit uses a layout condition relating to the layout condition of the character string to be obtained that has already been specified to evaluate the candidate character string.

5. The information processing apparatus according to claim 1, comprising a correcting unit configured to make correction so as to associate the partial image with a full image of the subject.

6. The information processing apparatus according to claim 5, wherein the correcting unit uses transformation of a feature point of the partial image into a feature point of the full image of the subject and transformation of the feature point of the full image of the subject into a feature point of a target image different from the partial image to correct the target image.

7. The information processing apparatus according to claim 1, further comprising a condition storage unit configured to store the condition.

8. The information processing apparatus according to claim 1, further comprising an imaging unit configured to capture images of a plurality of frames forming a moving image, wherein the acquisition unit acquires the image of the frame as the partial image.

9. The information processing apparatus according to claim 1, wherein the storage unit stores the character string that satisfies a predetermined condition as the candidate character string.

10. The information processing apparatus according to claim 9, wherein in a case where a reliability of a character string recognized in a partial image newly acquired by the acquisition unit is higher than a reliability of a character string that has already been stored in the storage unit, the storage unit stores the character string recognized in the newly acquired partial image as the candidate character string.

11. The information processing apparatus according to claim 1, comprising:
a detecting unit configured to detect a character string area from the partial image acquired by the acquisition unit; and
a recognizing unit configured to recognize a character from the character string area detected by the detecting unit.

12. The information processing apparatus according to claim 1, further comprising a display unit configured to display the partial image of the subject generated by the generating unit.

13. An information processing method comprising the steps of:
acquiring a partial image acquired by capturing a portion of a subject including character strings;
storing a candidate character string among character strings recognized in the partial image in association with a full image obtained by capturing the entire subject;
specifying a character string to be obtained by evaluating the candidate character string by using a condition relating to the candidate character string stored in the storing step; and
generating a partial image of the subject, the partial image of the subject including the character string to be obtained that is specified in the specifying step.

14. A non-transitory computer readable storage medium storing a program for causing a computer to function as a information processing apparatus, where the information processing apparatus comprises:
an acquisition unit configured to acquire a partial image acquired by capturing a portion of a subject including character strings;
a storage unit configured to store a candidate character string among character strings recognized in the partial image in association with a full image obtained by capturing the entire subject;
a specifying unit configured to specify a character string to be obtained by evaluating the candidate character string by using a condition relating to the candidate character string stored in the storage unit; and
a generating unit configured to generate a partial image of the subject, the partial image of the subject including the character string to be obtained that is specified by the specifying unit.
